(19) United States
(12) Patent Application Publication
(10) Pub. No.: US 2010/0308722 A1
(43) Pub. Date: Dec. 9, 2010

(54) Melting film, method for the production thereof, and lamp having such a film

(75) Inventors: Joachim Jens Bernhardt, Berlin (DE); Markus Stange, Berlin (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/866,742

(22) PCT Filed: Feb. 27, 2008
(86) PCT No.: PCT/EP08/52345

§ 371 Date: Aug. 9, 2010

(51) Int. Cl. H01J 5/32; F16J 15/02; B26D 7/08

(52) U.S. Cl. 313/623; 277/628; 277/650; 83/14

(57) ABSTRACT

A method for producing a seal-in foil for the gas-tight electrical feed in a lamp is provided. The seal-in foil may be separated from a foil perform. The method may include forming a weakened zone and separating the seal-in foil along the weakened zone.

### TECHNICAL FIELD

The invention relates to a method for producing a seal-in foil according to the preamble of patent claim 1, to a foil produced by such a method according to the preamble of coordinated patent claim 9, and to a lamp having such a foil according to the preamble of patent claim 11.

### PRIOR ART

Lamps of the species, for example halogen lamps, discharge lamps, high-pressure discharge lamps, have a lamp vessel, also referred to as a bulb, which contains a lighting means, for example a filament or—in the case of discharge lamps—electrodes. Depending on the lamp type, the electrical feeds assigned to the lighting means extend for example through a pinch, insertion seal or seal-in pinch of the lamp vessel. These embedding methods are to be understood as synonymous here, and will only be referred to below as an insertion seal. Directly sealing the electrical feeds, which conventionally consist of molybdenum or tungsten, into the glass (quartz) with the required leaktightness can only be carried out with difficulty since the expansion coefficients of this material pair differ considerably.

In the region of the seal, a thin molybdenum foil, which is referred to below as a seal-in foil and is welded on the one hand to an inner electrical feed on the lighting means side and on the other hand to an outer electrical feed which extends out of the lamp vessel/bulb, is therefore conventionally sealed in. After the lamp vessel has been closed, this foil is then fully embedded in the quartz glass of the lamp vessel by means of a seal-in unit, so that the electrical feed-through consisting of the electrical feeds and the foil is sealed gas-tightly in the lamp vessel end. These sealed-in foils therefore fulfill two different functions: on the one hand they serve to produce an electrically conductive connection between the inner and outer electrical feeds, and on the other hand they ensure gas-tight closure of the lamp vessel since the relative expansion between the foil and the quartz glass is so small that no separation normally takes place at the interface between the foil and the quartz.

Such welded-in foils are known for example from DE 10 2005 013 759 A1, DE 2005 034 673 A1 or DE 10 2004 061 736 A1. The electrical feed foils are conventionally cut from a foil web and have an approximately rectangular base surface which is bounded by two side edges—defined by the web width—and two cut edges extending perpendicularly thereto.

Owing to wear and design-related inaccuracies of the cutting/stamping tool, burring or roughly cut foil edges can occur along these cut edges, so that these defects can cause leaks of the electrical feed-through when sealed in, and therefore total failure of the lamp.

Various forms of hard metal blades may be used for cutting the seal-in foil, although these are also subject to wear. In order to cut sheet metal, wires, pins, etc., it is also known to use lasers, in particular short-pulse lasers—although the use of such cutting methods also entails irregularities due to solidified melts or to burrs or other cutting defects, which can lead to leaks during use of the lamp.

In order to avoid leaks, it is known from U.S. Pat. No. 4,587,454 to pretreat molybdenum foils by sandblasting.

In order to reduce the lamp failure rate, DE 29 47 230 proposes to alloy the molybdenum foils by adding yttrium oxide in the range of from 0.25 to 1 percent by weight.

GB 1,594,976 discloses a method in which the foil thickness decreases constantly starting from the center of the foil in the direction of the side edges, the foil being pretreated by means of an etching method in the region of the side edges.

EP 0 884 763 B1 describes a sealed-in molybdenum foil in which the cut edge is tapered in a wedge shape by a rolling method in order to reduce the susceptibility to tearing during operation of the lamp. The known sealed-in molybdenum foil is furthermore configured with a lancet-shaped cross section parallel to the cut edges, so that the mechanical stress in the sealed-in molybdenum foil is reduced by the convexly curved surface.

A disadvantage with the solutions described above is that considerable process technology outlay is required in order to form or finish the cut edges of the electrical feed foils.

### SUMMARY OF THE INVENTION

It is an object of the present invention to provide a method for producing a seal-in foil, a foil produced by such a method and a lamp configured with such a foil, such that the foil can be produced with little technical apparatus outlay and the operational reliability of the sealed-in foil is improved in comparison with known methods.

This object is achieved by a method as claimed in patent claim 1, a seal-in foil having the features of patent claim 9 and a lamp as claimed in coordinated patent claim 11.

Particularly advantageous configurations may be found in the dependent patent claims.

According to the invention, before a seal-in foil is separated from a foil preform, for example a foil web, a weakened zone is formed in a separating region and the foil is then separated along this weakened zone.

The foil can be separated with comparatively little outlay owing to the formation of this weakened zone, with the weakened zone defining the cutting profile and therefore the burr-free narrow side edge geometry of the foil.

The method according to the invention makes it possible to separate the foil in an extremely simple way, for example by a kind of “tearing”, by applying a tensile stress approximately transversely to the weakened zone so that the foil is separated from the foil preform along the predetermined profile when the yield point is exceeded. This separating process does not require any elaborate tools which are susceptible to wear. By this “tearing” of the foil and the concomitant exceeding of the yield point, the corresponding side edges of the foils are preferably tapered, with virtually no irregularities such as burrs extending perpendicularly to the large surface of the foil. In fact, the irregularities lying approximately in the foil plane, which are created during the “tearing”, have an advantageous effect for sealing in or pinching the foil. As seen macroscopically, the relevant foil side edge can be slightly frayed by this tearing, which further assists embedding of the foil in the insertion seal.

The weakened zone mentioned in the introduction may be formed mechanically, for example by stamping.

In principle, it is also possible to form this weakened zone by removing material on one or both sides. The widely known methods, for example machining, thermal ablation of material, chemical ablation of material or the like may in this case be used as methods of removing material.

For example, exposure to high-energy radiation, for example laser radiation, plasma radiation, electron/ion beam ablation or erosion may be envisaged as thermal ablation methods.

As an alternative, the weakened zone may also be formed by a structural modification in the separating region.

According to the invention, it is preferable for the foil to consist of molybdenum.

### BRIEF DESCRIPTION OF THE DRAWINGS

The invention will be explained in more detail below with the aid of several exemplary embodiments.

FIG. 1 shows a partial representation of a sealed-in foil of a discharge lamp;

FIG. 2 shows an outline representation of a method for separating a foil from a foil preform;

FIG. 3 shows method steps of a first method according to the invention for producing a seal-in foil;

FIG. 4 shows an alternative method for producing a seal-in foil by removing material;

FIG. 5 shows a third exemplary embodiment of a method for producing a seal-in foil by structural modification and

FIG. 6 shows exemplary embodiments of foil geometries.

### PREFERRED EMBODIMENTS OF THE INVENTION

An exemplary embodiment of a discharge lamp will be explained below. As already mentioned in the introduction, however, application of the invention is not restricted to such discharge lamps or high-pressure discharge lamps, but may be used in principle for all types of lamps in which a sealed-in foil is employed as an electrical feed-through.

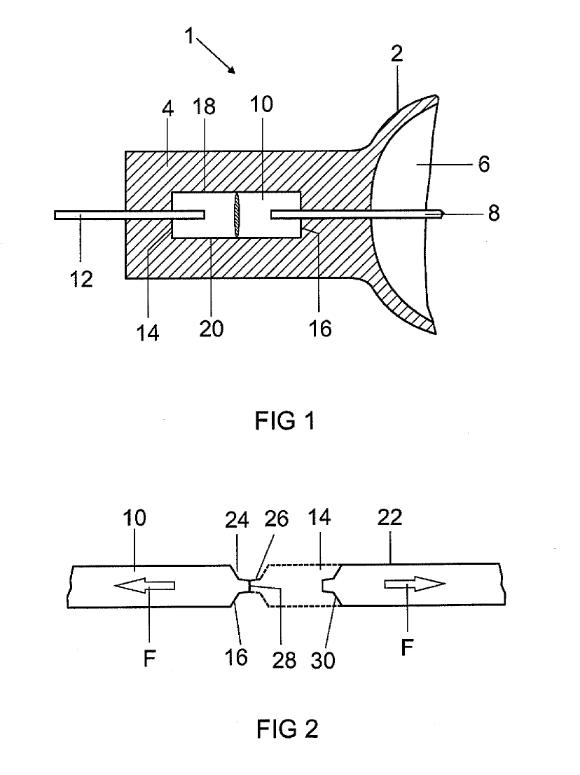

FIG. 1 shows a partial representation of a high-pressure discharge lamp 1—also referred to as a bulb. It has a discharge vessel 2, at each end section of which a shaft 4 is formed via which the interior of the lamp vessel 2 is sealed by means of an insertion seal. The interior 6 of the discharge vessel 2 contains an ionizable fill, which consists for example of highly pure xenon gas and a plurality of metal halides. Electrodes, between which the discharge arc extends during operation of the lamp, project into this interior 6. The electrodes (not shown in FIG. 1) are respectively supported by an electrode rod 8, one end section of which extends into the interior 6 and the other end section of which is inserted into the region of the insertion seal of the bulb shaft 4. This end section of the electrode rod 8 is connected via a molybdenum foil 10 to an outer electrical feed 12. In the representation according to FIG. 1, this molybdenum foil 10 has a straight cut edge perpendicular to the foil longitudinal axis, the electrical feed 12 and the electrode rod 8 being welded to the molybdenum foil 10 in the region of the shorter side edges and extending coaxially with one another. As indicated in FIG. 1, the molybdenum foil 10 does not have a rectangular cross section but a slightly lancet-shaped cross section, which is obtained by electrolytic ablation. This lancet shape is represented somewhat exaggeratedly in the representation according to FIG. 1 for illustration.

The molybdenum foil 10 represented in FIG. 1 is separated from a foil web, the separation being carried out along the narrow sides 14, 16. The two longer longitudinal edges 18, 20 are defined by the width of the foil web. During manufacture, the molybdenum foil 10 is separated with the appropriate length from the foil web according to the lamp type, a particular method which is explained with the aid of FIGS. 2 to 5 being employed according to the invention.

The diameter of the electrical feed 12 and the electrode rod 8 is substantially greater than the foil thickness. When using a lancet shape, the maximum thickness of the foil (perpendicular to the plane of the drawing in FIG. 1) is for example about 1/100 to 1/50 of the foil width (transverse to the axis of the electrical feed 12). Further explanations concerning the structure of the discharge lamp 1 are superfluous, since it is not essential to the invention.

As already mentioned above, the molybdenum foil 10 is separated with the appropriate length from a foil web 22 or another foil preform. According to the invention, however, this is not done—as in the prior art—by a cutting or stamping method or by folding, but instead a weakened zone 24 is initially formed according to FIG. 2 and in a subsequent working step the molybdenum foil 10 (seal-in foil) is separated from the foil web 22 by applying a tensile stress. This tensile stress is applied by the traction forces F indicated in FIG. 2, which act on the foil in opposite directions. According to the invention, this tensile stress is configured so that the foil material is loaded beyond the yield point in the region of the weakened zone 24 and correspondingly tears, the tearing profile being defined by the weakened zone 24. Owing to the plastic deformation when exceeding the yield point, the corresponding narrow side (the narrow side 16 in the representation according to FIG. 2) tapers until a comparatively narrow stub 26 remains, and the tear 28 then extends through this. The state of the foil web 22 just before tearing occurs is represented by dashes in FIG. 2.

After the yield point has been exceeded, the molybdenum foil 10 is separated from the foil web 22 so that the tapering cross-sectional profile with a part of the stub 28 is formed both on the narrow side 16 of the molybdenum foil 10 and on the remaining tear edge 30 of the foil web 22. The tear need not extend exactly in a straight line and may be somewhat “frayed”, so that the embedding of the molybdenum foil 10 in the bulb shaft 4 is improved. As already mentioned, this weakened zone 24 may be formed on both sides or on one side. What is important is that this weakened zone 24 is configured so that the propagation direction of the tear when applying the tensile stress is predetermined and the desired foil geometry is obtained.

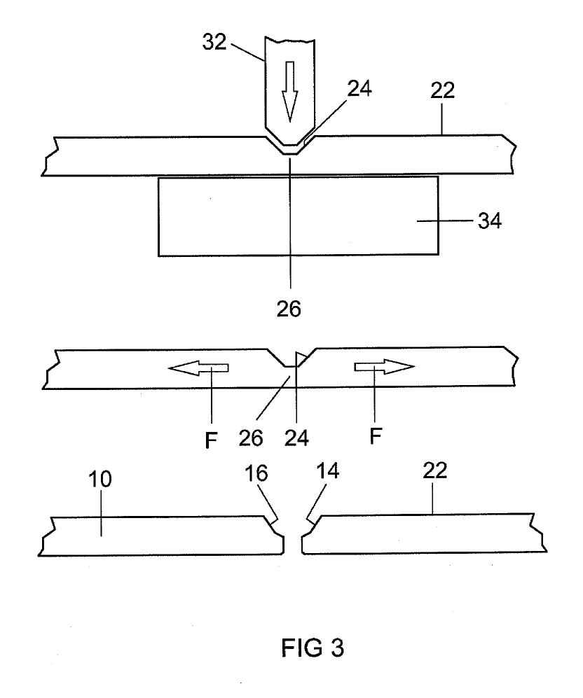

There are many options for the way in which the weakened zone 24 is formed. FIG. 3 shows a variant in which the weakened zone 24 is shaped by a stamping, the weakened zone 24 being formed by a correspondingly formed stamping tool 32 which is applied onto the foil web 22 supported on a bottom die 34. In the exemplary embodiment represented, the weakened zone 24 is configured approximately V-shaped with a horizontal base delimiting the stub 26, although in order to influence the tearing behavior, for example in order to accelerate the tear propagation speed, sharper cuts may in principle be provided so that the kerf stresses at the kerf edge are increased.

After the approximately V-shaped weakened zone 24 has been formed, the tensile stress is applied, the traction forces F lying approximately in the plane of the foil so that the molybdenum foil 10 is then torn off from the foil web 22 along the stub 26. The V-shaped weakened zone 24 may in this case be widened—as represented in FIG. 2.

The stamping is carried out on one side in the exemplary embodiment described above, although stamping on both sides may of course also be provided—similarly as in the exemplary embodiment explained with the aid of FIG. 2.

Instead of reshaping, the weakened zone 24 may also be formed by removing material.

All known methods, for example a machining method, a chemical method (etching), a thermal method such as for example exposure to energetic radiation (laser, plasma, electron beam/ion beam) or erosion, may in principle be used here to remove the material.

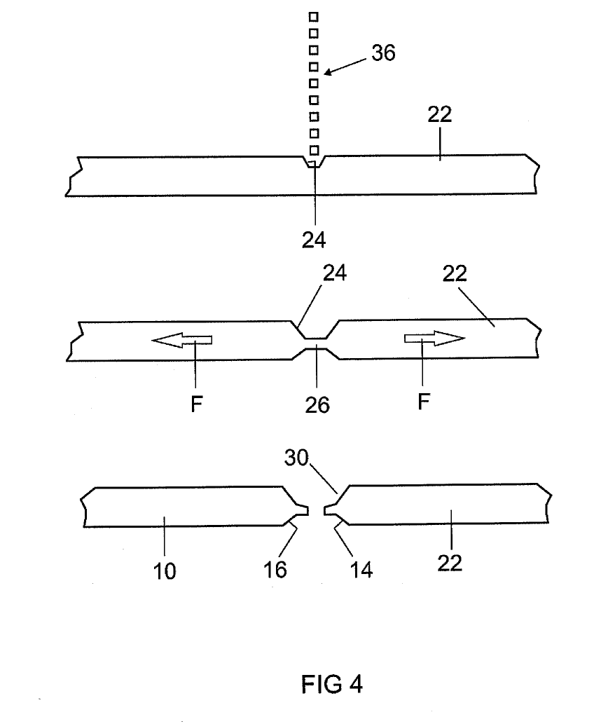

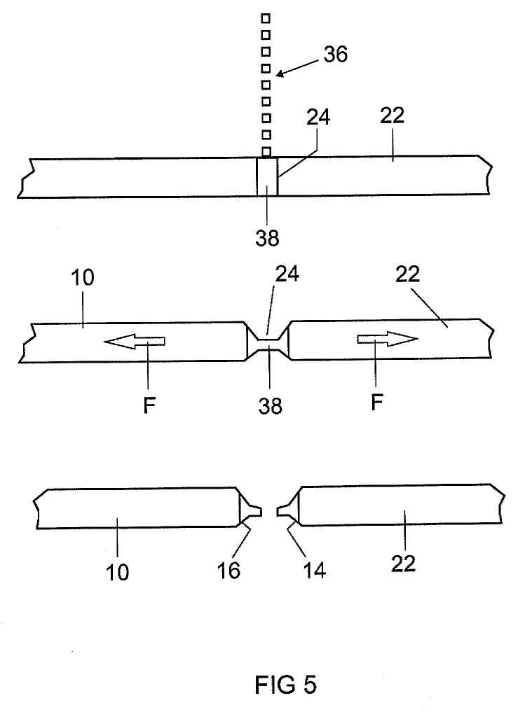

In the exemplary embodiment represented in FIG. 4, the weakened zone 24 is correspondingly formed by removing material by means of a laser beam 36, in which case an ultrashort laser with a pulse length in the range of from 10⁻¹⁵ seconds to 10⁻⁹ seconds may for example be used. Other laser types may of course also be used. The weakened zone 24 may in principle be formed continuously or in the form of a perforation. As in the exemplary embodiment described above, the weakened zone 24 may be configured on one side or on both sides.

After having made the weakened zone 24, which is formed in any desired way, the foil web 22 is in turn exposed to a tensile stress until the seal-in foil 10 tears along the weakened zone 24, a conically tapering burr-free narrow side 16 being formed. A correspondingly configured edge 30 is then created on the foil web 22—as in the exemplary embodiments described above—which then forms the narrow side 14 of the next seal-in foil 10 when the latter is torn off.

In the exemplary embodiments described above, the weakened zone 24 is formed either mechanically or by energetic irradiation, the tear profile being defined by the geometry of the weakened zone 24.

FIG. 5 shows a variant in which the weakened zone 24 is not formed by altering the foil geometry, but in which the weakened zone 24 is instead formed by structural modification. That is to say, the weakened zone 24 is formed by deliberate structural modification without a geometrical alteration. This structural modification may, for example, be induced by the action of a laser beam 36. When a predetermined recrystallization temperature is exceeded, for example, a local structural modification 38 may be formed as a weakened zone 24 so that when the tensile stress is applied, the seal-in foil 10 is deformed beyond the yield point along this structural modification 38 and tears, correspondingly tapered narrow sides 14, 16 likewise being formed again which are free of any burrs protruding from the large surfaces of the foil 10 or other irregularities.

The energy input by the laser beam 36 is preferably adjusted so that the structural modification assists the tear propagation, and embrittlement, and therefore brittle fracture without deformation, are prevented. In principle, the tear propagation may also take place without deformation in the weakened zone.

The temperature for the structural modification will be adjusted as a function of the material being used (molybdenum, tungsten) and with a view to the optimal deformation and tearing behavior.

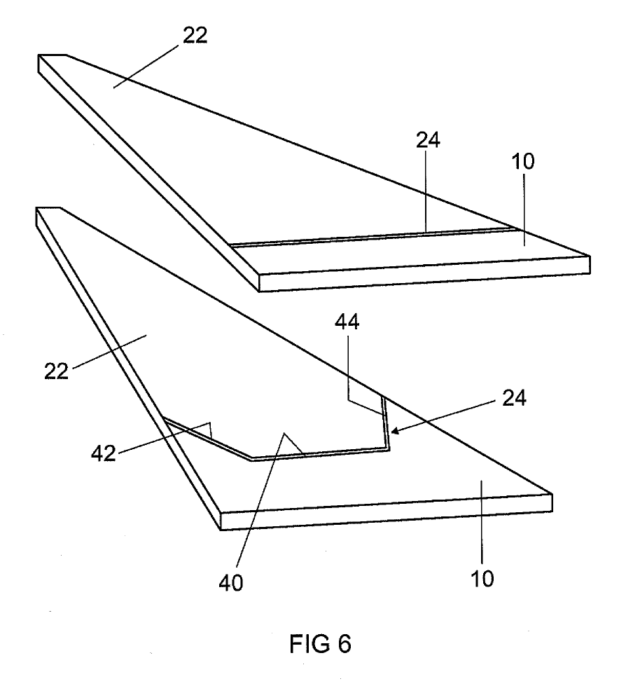

The procedure according to the invention, with the formation of a weakened zone 24 to define a tear propagation direction, readily makes it possible to form geometries differing from the rectangular shape which is represented. This will be explained with the aid of FIG. 6.

FIG. 6 represents the foil web 22 in a modified shape. According to the explanations above, in a first working step a weakened zone 24 is formed and then the seal-in foil 10 is torn off by applying traction forces extending approximately in the plane of the foil web, the tear profile being defined by the weakened zone 24. FIG. 6, top, represents the formation of a conventional rectangular seal-in foil 10. With the aid of the exemplary embodiment represented in FIG. 6, bottom, it will be explained that the weakened zone 24 need not be configured in a straight line, but instead virtually any desired geometries may be envisaged which are merely limited in view of the optimized tearing behavior. In the exemplary embodiment represented, the weakened zone 24 is configured approximately trapezoidal or V-shaped with a wide base 40 and side edges 42, rising obliquely therefrom. In this case, the geometry or the profile of the weakened zone 24 may be selected as a function of the tearing behavior or the geometry of the associated electrical feeds, or the spatial requirements in the insertion seal.

A method for producing a seal-in foil, a seal-in foil produced by such a method, and a lamp having such a seal-in foil, are disclosed. According to the invention, this seal-in foil is separated from a foil preform on which a weakened zone is previously formed.

1. A method for producing a seal-in foil for the gas-tight electrical feed in a lamp, the seal-in foil being separated from a foil preform, the method comprising:
forming a weakened zone and
separating the seal-in foil along the weakened zone.

2. The method as claimed in patent claim 1,
wherein the separation is carried out by applying a tensile stress approximately transversely to the weakened zone.

3. The method as claimed in patent claim 1,
wherein the weakened zone is formed mechanically.

4. The method as claimed in patent claim 1,
wherein the weakened zone is formed by removing material.

5. The method as claimed in patent claim 4,
wherein the weakened zone is formed by machining, thermally or chemically.

6. The method as claimed in patent claim 5,
wherein the weakened zone is formed by high-energy radiation, for example by a laser beam, plasma beam, electron/ion beam or by erosion.

7. The method as claimed in patent claim 1,
wherein the weakened zone is formed by structural modification.

8. A seal-in foil, comprising:
at least one circumferential edge being formed essentially without burrs by separation along a weakened zone.

9. The seal-in foil as claimed in patent claim 8,
wherein the circumferential edge is formed by deformation beyond a yield point.

10. The seal-in foil as claimed in patent claim 8, which consists essentially of molybdenum.

11. A lamp, comprising:
a lamp vessel that encloses a lighting means and is configured with a pinch or insertion seal in which a seal-in foil is embedded while being connected on the one hand to an inner electrical feed and the lighting means and on the other hand to an outer electrical feed, the seal-in foil comprising at least one circumferential edge being formed essentially without burrs by separation along a weakened zone.

12. The method as claimed in patent claim 3,
wherein the weakened zone is formed by stamping.

13. The method as claimed in patent claim 6,
wherein the weakened zone is formed by high-energy radiation selected from a group consisting of: by laser beam, by plasma beam, by electron/ion beam, and by erosion.

14. A seal-in foil produced by a method for producing a seal-in foil for the gas-tight electrical feed in a lamp, the seal-in foil being separated from a foil preform, the method comprising:
forming a weakened zone and
separating the seal-in foil along the weakened zone,
wherein at least one circumferential edge is formed essentially without burrs by separation along a weakened zone.

15. The seal-in foil as claimed in patent claim 8,
wherein the weakened zone is configured with a taper.
